(19) United States
(12) Patent Application Publication
(10) Pub. No.: US 2014/0197764 A1
(43) Pub. Date: Jul. 17, 2014

(54) DEVICE FOR STABLE SUBSEA ELECTRIC POWER TRANSMISSION TO RUN SUBSEA HIGH SPEED DC MOTORS OR OTHER SUBSEA DC LOADS

(71) Applicant: Kjell Olav Stinessen, Oslo (NO)

(72) Inventor: Kjell Olav Stinessen, Oslo (NO)

(73) Assignee: Aker Subsea AS, Lysaker (NO)

(21) Appl. No.: 14/238,130

(22) PCT Filed: Sep. 11, 2012
(86) PCT No.: PCT/NO2012/050173

§ 371 Date: Feb. 10, 2014

(30) Foreign Application Priority Data
Sep. 12, 2011 (NO) 20111235

(51) Int. Cl. H02M 7/30; H02M 7/06; H02P 7/00; H02M 7/04

(52) U.S. Cl. CPC H02M 7/30; H02M 7/04; H02M 7/06; H02P 7/00
USPC 318/3; 363/13; 363/102; 363/125; 363/126

(57) ABSTRACT

Device for operative connection between a subsea step out cabie far end and subsea toads such as pumps, compressors and control systems, distinctive in that the device is a subsea DC provider (SDCP), and it comprises: a SDCP unit for altering alternating current power received from the step out cable to direct current power for delivery to said loads, a gas and/or liquid filled vessel into which said unit is arranged, and the device is a SDCP for subsea location at a far end of a subsea step out cable connected to at least one AC power source at the step out cable near end, and the step out length is long, which means long enough to cause, stability problems at frequency and power levels feasible for subsea pump and compressor motors, and where the device via the step out cable receives input electrical power at a low enough frequency to have stable transmission and the device, operativeSy connected to the subsea motors, delivers a DC output electrical amperage and voltage feasible for operation of connected pump and compressor motors. System for subsea pressure boosting of hydrocarbon fluid or other fluid, comprising the device.

### FIELD OF THE INVENTION

The present invention relates to equipment for subsea production of petroleum, particularly equipment located far away from dry topside or onshore locations. More specifically, the invention relates to equipment for electric power transmission to subsea loads that can be located far away from surface platforms or shore and require high power transmission. Said loads are typically motors for pumps and compressors which according to state of the art technology require control of rotational speed by control of the electric frequency.

The invention come to grips with the problems caused by the Ferranti effect and the skin effect, thereby opening up for longer subsea step out lengths than previously achievable.

### BACKGROUND OF THE INVENTION AND PRIOR ART

Over the last decades global energy consumption has increased exponentially and no end can be seen for the increased demand. Whereas exploitation of fossil fuels was previously focused on onshore fields, the limited amount of oil started serious efforts to find and exploit offshore gas and oil fields. Presently the state of the art for production from offshore fields is by use of fixed or floating manned platforms, and by tie-in of subsea production templates with subsea wells to these platforms. In some cases production is routed directly to an onshore receiving facility without a platform. In order to maintain a sufficiently high production from subsea satellites to a central platform or directly to shore, pressure boosting can be provided by using a multiphase pump or by separation followed by pumping and compression. Pumps have also been installed at seabed for direct seawater injection into the reservoir for pressure support for enhanced oil production.
There are several advantages that motivate for subsea location of pumps and compressor stations compared to location on platforms:
Safety for people by not working and living on platform and not being transported by helicopters to and from
No risk of fire and explosion
No risk for blow-out from production risers up from seabed to platform and from platform to seabed
Security against sabotage
Cost saving both for capital and operation, i.e. reduced production cost for oil and gas
Increased production because the suction effect of compressors and pumps is closer to the wellheads
The equipment has stable ambient conditions, i.e. almost constant, cold temperature and almost constant, low flow seawater current velocity around the equipment and no waves, while the temperature at platforms can vary from e.g. −20° C. to +30° C. and the wind velocity can be at hurricane strength combined with extremely high waves.
The cold seawater can be utilized for cooling of motors and other electric and electronic equipment and process fluids
No visual pollution
Considerably lower weight and thereby lower material and energy amount for fabrication of a subsea plant
Lower carbon dioxide, i.e. climate gas emission for fabrication due to less material amount
Less carbondioxide emissions during operation due to elimination of helicopter transport and operation of platform
Less carbondioxide emission compared to platforms due to electric motors for running compressors and pumps and supply of electric power from shore or platform
Less energy consumption and climate gas emission per weight unit of oil and gas

The disadvantage for subsea compressors per 2010 is that none has been installed and operated subsea, i.e. the technology is not proven. However, this is just a question of time, and the first subsea compressor station will probably be in operation in 2015 or earlier due to the strong motivation for this application.

Subsea pressure boosting is a recent technology. Subsea pressure boosting requiring a significant subsea step out length is a very recent technology using modern equipment and facing problems that are not met or is irrelevant elsewhere.

State of the art technology is defined in patent publication WO 2009/015670 prescribing use of a first converter arrangement in the near end, the topsides or onshore end, of a subsea step out cable and a second converter arrangement in the far end, the subsea remote end, of the subsea step out cable. A variable speed drive, VSD, is prescribed in either end of the step out cable. Subsea variable speed drives (VSD) for electric motors is also called variable frequency drive (VFD) and frequency converters or just converters and they represents state of the art technology. Neither in WO 2009/015670 or other publications is the Ferranti effect mentioned, nor is any problem associated with subsea VSDs discussed or indicated.

So far only a few subsea pumps and no subsea compressors are in operation. Subsea compression stations are however being developed and the first expected to be installed and in operation within some few years. Currently, subsea pumps and compressors are all driven by asynchronous motors. The step-out distance of installed pumps is not more that about 30 km from platform or shore and so far the depths are not below 1800 m. It is known that serious studies and projects are conducted by the oil industry aiming at installation of compressors at a step-out distance in the range of 40 to 150 km and at water depth down to 3000 m or more.

A realistic motor power is from about 200 kW for small pumps and up to 15 MW for compressors and in the future even larger motors can be foreseen. Subsea motors that are presently installed are supplied with power via AC (alternating current) cables from the location of the power supply, i.e. platform or shore, and in case of several motors each motor has its own cable and frequency converter (Variable Speed Drive, VSD) at the near end of the cable in order to control the speed of each individual motor at the far end of the cable, ref. FIG. 1 and Table 2.

In the context of this patent description near end means the end of the power transmission near to the power supply. In subsea applications this is topsides platform location or onshore. Correspondingly, the far end refers to the other end of the transmission line close to the power loads, typically motor loads. Far end is not necessarily restricted to the high-voltage end of the transmission line. The term can be extended to busses or terminals of lower voltage which are part of the far end station such as e.g. a common subsea bus on the low-voltage side of a subsea transformer.

Compressors and pumps are often operated at maximum speeds between 4000 to 14000 rpm and 2000 to 5000 rpm, respectively. Thus the driving electrical motor has to have a rated speed in the order 2000 to 14000 rpm when using modern high speed motors without a gearbox between the motor and the pump or compressor. This mechanical speed corresponds to an electrical frequency range for the feeding drive of about 30 to 230 Hz for the example of a two-pole motor. Motors with more pole pairs would allow for lower maximum mechanical speed for the same electrical frequencies.

FIG. 1 illustrates the only solution so far used for transmission of electric power to installed pumps, in some cases without transformers between VSD and subsea motors, and this is referred to as First solution. This solution with one transmission cable per motor has the disadvantage of becoming expensive for long step-out; say more than 50 km, due to high cable cost.

A serious technical obstacle against this solution is that at a certain subsea step-out length, the transmission of electric power from a near end power source to a far end distant motor is not feasible because the transmission system will become electrically unstable and inoperable due to the Ferranti effect that later will be described. The innovation will resolve this problem of instability.

FIG. 2 illustrates a solution that has been proposed for transmission of electric power to several loads at long step-out, Solution Two. This solution with one common transmission cable and a subsea power distribution system including one subsea VSD (Variable Speed Drive) per motor, will considerably reduce the cable cost for transmission, and also prevent the problem of electric instability by limiting the frequency of the current in the transmission cable to say 50-10 Hz, and the skin effect is also acceptable for such frequencies. The frequency is then increased by a VSD to suit the speed of the motor connected to the VSD. The Second Solution has however also disadvantages. These are expensive VSDs which are not proven for subsea use, and because such VSDs are composed of many electric and electronic components included a control system, they are susceptible to contribute to an increased failure rate of the electric transmission and subsea distribution system.

In the following will be described the inherent electrical problems of the existing First Solution (FIG. 1), with one motor at the far end of a long cable, and a Third Solution illustrated in FIG. 3 with several motors at the far end of a common long transmission and a common VSD at the near end.

For a long step-out distance from the power supply to the load, in the order of 50 km and above, the influence of the subsea cable is so strong that such a system has not been built yet for a limited load such as a single motor. The line inductance and resistance involve a large voltage drop from the power supply to the load. It is known that such a voltage drop is self-amplifying and can result in zero voltage at the far end. The longer the step-out distance the higher the transmission voltage has to be in order to reduce the voltage drop along the transmission line. However, a cable has a high capacitance and a long AC (alternating current) cable will exhibit significant so-called Ferranti effect. The Ferranti effect is a known phenomenon where the capacitive charging current of the line or cable increases with the line length and the voltage level. At a step-out length of 100 km the charging current in a cable can be higher than the load current, which makes it difficult to justify such an ineffective transmission system. A more critical result is that the no-load voltage will be about 50% higher than the near end supply

Voltage that would destroy the cable and the far end transformer and connections. At a sudden load drop the far end voltage will jump to this high level. In addition there will be a transient peak of e.g. 50% giving like 100% in total, see Table 1 below where values marked with fat italic letters are above the voltage class margin of the insulation.

Today's systems with step-out distances in the order 30 km have not this problem, because the subsea step-out length and electric load in combination is still feasible.

TABLE 1
Voltage rise at load trips due to Ferranti effect in different systems

| | Max. transmission | | | | | | Far end transient |
|---|---|---|---|---|---|---|---|
| | frequency fₘₐₓ and | | | | Source voltage at near | Full-load and no-load | voltage peak uₚ after |
| Far end shaft power | motor speed ωₘₐₓ | Step-out length | Standard cable | | end U | voltage U | full-load trip |
| Pump | 60 Hz | 40 km | 95 | mm² | 20 kV | 18.3 kV | 20.9 kV |
| 2.5 MW | (3600 rpm) | | 30(36) | kV | | 20.2 kV | |
| First Solution | | | | | | | |
| Compressor | 180 Hz | 40 km | 150 | mm² | 32 kV | 29.2 kV | [symbol] |
| 7.5 MW | (10800 rpm) | | 30(36) | kV | | 34.8 kV | |
| First solutions | | | | | | | |
| Pump | 60 Hz | 100 km | 150 | mm² | 26 kV | 23.6 kV | 28.9 kV |
| 2.5 MW | (3600 rpm) | | 30(36) | kV | | 27.5 kV | |
| First Solution | | | | | | | |
| Compressor | 180 Hz | 100 km | 150 | mm² | 28.5 kV | 28.8 kV | [symbol] |
| 7.5 MW | (10800 rpm) | | 30(36) | kV | | [symbol] | |
| First Solution | | | | | | | |
| Three | 180 Hz | 100 km | 400 | mm² | 45.6 kV | 45.6 kV | [symbol] |
| compressors and | Compressor: | | 45(54) | kV | | [symbol] | |
| three pumps. | 10800 rpm | | | | | | |
| Total 30 MW | Pump: | | | | | | |
| Third solution | 5400 rpm | | | | | | |

The Ferranti effect and skin effect some considerations:

The Ferranti effect is a rise in voltage occurring at the far end of a long transmission line, relative to the voltage at the near end, which occurs when the line is charged but there is a very light load or the load is disconnected.

This effect is due to the voltage drop across the line inductance (due to charging current) being in phase with the sending end voltages. Therefore both capacitance and inductance are responsible for producing this phenomenon. The Ferranti effect will be more pronounced the longer the line and the higher the voltage applied. The relative voltage rise is proportional to the square of the line length.

Due to high capacitance, the Ferranti effect is much more pronounced in underground and subsea cables, even in short lengths, compared to air suspended transmission lines.

A proposed equation to determine the Ferranti effect for a given system is:

v_{f}=vₙ(1+ω×C×L×I²)

Where:

v_{f}=far end voltage

vₙ=near end voltage

ω=2×3.14×f

f=frequency

C=line capacitance

L=line inductance

I=line length

I²=line length square

In the literature can also be found other expressions for the Ferranti effect, but in any cases it is agreed that the effect increases with transmission frequency, cable capacitance, length of cable and voltage.

From the above equation can be concluded that the Ferranti effect of a long line can be compensated by a suitable reduction of the electric frequency. This is the reason for the Second Solution with subsea VSD. The transmission frequency can e.g. be the normal European frequency of 50 Hz.

Another benefit with low transmission frequency is a strong reduction of the electrical skin effect of the transmission cable, i.e. better utilization of the cross section area of the cable. In practice transmission of high frequency electricity, say 100 Hz or more over ling distances, say 100 km or more, will become prohibitive due to the skin effect and the corresponding high resistance of the cable.

The influence of Ferranti effect and skin effect has of course to be calculated from case to case to assess whether they are acceptable or not for transmission at a given frequency. A demand exists for providing subsea electric power transmission systems that are beneficial with respect to the above mentioned problems and without introducing subsea VSDs.

### FIGURES

The invention is illustrated with figures, of which

FIGS. 1-3 illustrate prior art embodiments, and

FIGS. 4 and 5 illustrate an embodiment of the present invention.

### SUMMARY OF THE INVENTION

The invention provides a device for operative connection between a subsea step out cable far end and subsea loads such as pumps, compressors and control systems, distinctive in that the device is a subsea DC provider (SDCP), and it comprises:
a SDCP unit for altering alternating current power received from the step out cable to direct current power for delivery to said loads,
a gas and/or liquid filled vessel into which said unit is arranged, and
the device is a SDCP for subsea location at a far end of a subsea step out cable connected to at least one AC power source at the step out cable near end, and the step out length is long, which means long enough to cause stability problems at frequency and power levels feasible for subsea pump and compressor motors, and where the device via the step out cable receives input electrical power at a low enough frequency to have stable transmission and the device, operatively connected to the subsea motors, delivers a DC output electrical amperage and voltage feasible for operation of connected pump and compressor motors.

The device of the invention comprises one of: a motor-DC generator set or a static rectifier, and preferably the device comprises a pressure compensator.

In one preferable embodiment the device is a SDCP, for subsea location at a far end of a subsea step out cable connected to at least one power source at the step out cable near end at a dry location onshore or topsides, and the step out length is long, which means long enough to cause problems due to the Ferranti effect at frequency and power levels feasible for subsea pump and compressor motors, and where the device via the step out cable receives input electrical power at a low enough frequency to have stable transmission and the device, operatively connected to the subsea motor, delivers an output electrical amperage and voltage feasible for operation of the connected motors and the device is installed in a pressure vessel or housing that is filled with liquid or gas A VSD can be connected at the step out cable near end to adjust a step out cable low frequency power transmission. Preferably the transmission frequency from the power source at the near end is fixed

No earlier subsea pressure boosting systems has taken into consideration the Ferranti effect. The earlier system version with a subsea VSD can therefore be useless for many applications since the insulation of the step out cable can be damaged by uncontrollable high voltage at the far end due to the Ferranti effect. The device of the invention is a passive slave unit, namely a passive rectifier. A subsea VSD is very complex, large and expensive, it is typically about 12 m high, 3 m in diameter and weights about 200 tons. The passive device will to the contrary be much smaller and simpler, being typically about 6 m long and 2-3 m in diameter, weighting about 50 ton. The reliability of the device is estimated to be several times better than for a subsea VSD. This is because a subsea VSD is very complex, and even though all components of a subsea VSD are of top quality the large number of components and the complexity results in a reduced reliability in practice. The cost of the device or a system of the invention will be significantly reduced compared to the state of the art systems having a subsea VSD. The term other loads comprises power to control systems and other loads not necessarily related to pressure boosting.

The operation frequency of the step out cable must be considered taking into account the Ferranti effect and the electrical losses. The insulation is a key element. Most preferably, the dimensions of conductors and insulation, and choice of operation frequency, are so that at the far end of the cable, the Ferranti effect, at its maximum during operation, increases the voltage just as much as the electrical losses, hence overvoltage at the far end due to the Ferranti effect is avoided and the cable design is simplified. The guidance provided in this document, combined with good engineering practice, is assumed to be sufficient for proper step out cable design, including choice of operation frequency: The solution should be found in each case. The device of the invention, the SDCP, either rectifies the operation frequency of the step out cable to DC or alternatively it produces DC by a subsea motor-DC generator set (SDCS) for the subsea loads, i.e. subsea compressors or pumps, or more specifically, the motors of the subsea compressors or pumps, or other loads such as control systems equipment.

Further embodiments and features are defined in the dependent claims. The features described or illustrated in this document can be included in the device of the invention in any operative combination, and each such combination is an embodiment of the invention. The motivation for such combinations is based upon what is described or illustrated or the combinations are those obvious for persons skilled in the art after having studied this document thoroughly.

The input frequency, the operation frequency of the step out cable, will be in the range 0, 1-150 Hz, such as 2-60 or 4-50 Hz or 5-40 Hz, or 1-10 HZ, whilst the output frequency will be 0, that is direct current DC. The subsea device can be arranged in one or several housings, as one or several elements, however, all parts of it must withstand the harsh subsea environment without failure. With the present invention, the long term cost and reliability of said device, and associated systems, improve significantly over what is currently achievable with for example subsea solid state variable speed drives.

The invention also provides a system for subsea pressure boosting of hydrocarbon fluid or other fluid, comprising
a subsea step out cable, connected to a an electric AC power source at a near end, the length of the subsea step out cable is too long for stable operation at frequency and power level feasible for subsea pumps or compressors,
subsea pumps or compressors operatively connected to a far end of the subsea step out cable,
distinctive in that the system further comprises a subsea DC provider arranged between the subsea step out cable and DC motors of subsea pumps or compressors.

Preferably, the subsea DC provider comprises one of: a motor-DC generator set (SDCS) or a static rectifier (SSR), arranged in a vessel filled with liquid or gas, and preferably, the subsea DC provider has no means for active control or adjustment on, site subsea, the subsea DC provider is arranged in a liquid filled vessel, with a pressure compensator and at least one electric penetrator.

In addition, the invention provides use of a subsea direct current provider device of the invention for transforming the electrical power characteristics of a subsea step out cable to DC for operation of connected subsea equipment, a system with at least one subsea direct current provider device of the invention arranged in the far end of a subsea step out cable, and a method of operating said system, by control adjustments only for system items at dry topsides or onshore locations, such as by a topsides VSD. Either one of the device, the system, the method or the use of the invention, may comprise any features or steps as herein described or illustrated, in any operative combination, each such operative combination is an embodiment of the invention.

There will be some power loss in a subsea rectifier, say 2 to 5%, but a subsea VSD will also have losses, however perhaps lower.

### Design of Subsea of a Subsea DC Provider (SDCP) of the SDCS Type

### Oil Filled Pressure Housing

The SDCS is assembled in a pressure housing with a suitable number of flanges with seals. Further there are several options for the practical design, which are listed in the following:

The SDCS has a suitable number of radial bearings.

The rotational speed of the SDCS is low enough to keep the frictional losses acceptable, and the pressure housing is filled with a suitable liquid, e.g. oil, that lubricates the bearings and also cools motor and generator and the properties of the selected oil should preferably be such that it serves as electric insulator.

Instead of oil, the housing can be water filled with water or a mix of water and antifreeze agent, e.g. MEG, which requires a complete electrical insulation of the SDCS windings.

The pressure inside the housing can be selected freely by not filling it completely with liquid and have a gas volume at some pressure.

A favourable solution is to fill the housing with liquid and have pressure balancing device between the ambient seawater and the internal liquid of the pressure housing. This will result in a minimum thickness of the pressure housing and also reduce the load and requirements to flanges and seals If the direct cooling of the SDCS by heat flow through the pressure housing and to the sea is too low, an external cooling circuit with heat exchange to the ambient seawater has to be included.

The pump for the cooling circuit can favourably be coupled to the SDCS shaft or it can be a separate pump with electric motor.

If magnetic bearings for operation in liquid are available, this could be an option to liquid lubricated bearings. For more details about this, reference is made to the description below for gas filled housing.

### Gas Filled Housing

The pressure housing can be filled with an inert gas, e.g. dry nitrogen or dry air. The advantage of this is lower frictional losses than for oil filled, which allows higher speed of motor-generator. Additionally the practical solution can include the following:

Liquid lubricated bearings (e.g. oil, water or water/MEG) with a circulating circuit through an external heat exchanger or only inside the housing.

Minimum one pump for the lubricant, either driven by the SDCS shaft or a separate electric pump

If necessary a cooling circuit for the gas is included by having minimum one fan to circulate the gas through an external heat exchanger or only inside the housing.

Alternatively to liquid lubricated bearings, magnetic bearings can be used. The cooling system for the gas must then be dimensioned to also cool the magnetic bearings.

A control system for the magnetic bearings must be included, located in the vicinity of the SDCS housing or inside the housing. If the control system is located in a pod outside the SDCS housing, penetrators through the housing wall are needed as well as wires for power and signals between the control system and the magnetic bearings. If the control system is in a pod, the pod can be designed to be separately retrievable or not. The pressure inside the housing can be selected from in the region of one bar and up to equal to the ambient water pressure or higher. The advantage of low pressure is low friction and losses. The advantage of high pressure is that the heat capacity of the gas increases with pressure and therefore gives better cooling. Another advantage of high pressure is also reduced requirement to wall thickness and lower load on flanges and seals. If the pressure is selected close to equal to ambient seawater pressure, the resulting requirements to the pressure housing and flanges and seals will be similar to a liquid filled pressure balanced vessel.

### Subsea Static Rectifier (SSR)

Alternatively to a SDCS can be used a subsea static rectifier (SSR) provided that such a device can be made in a simplified version compared to a subsea variable speed drive and with acceptably high robustness, reliability and availability.

### Some Elements of a Practical Solution can Include:

The components of the subsea SSR can be assembled in a pressure vessel filled with a suitable liquid, e.g. insulating oil that is also cooling the electronic and electrical components

The internal oil can be pressure balanced to the ambient seawater or the pressure can be kept at a level between one bar and ambient pressure decided by the pressure tolerance of the components.

The control system can be located inside the pressure housing, but more favourable in a separate external pod (ref is made to the above description of Gas filled housing for details).

The control system can be located at surface (topsides or onshore).

Alternatively to a liquid filled vessel can be used a vessel filled with inert, dry gas, e.g. dry nitrogen. The pressure inside the housing can be selected from in the region of one bar and up to equal to the ambient water pressure or higher. The advantage of high pressure is that the heat capacity of the gas increases with pressure and therefore gives better cooling. Another advantage of high pressure is also reduced requirement to wall thickness and lower load on flanges and seals. If the pressure is selected close to equal to ambient seawater pressure, the resulting requirements to the pressure vessel and flanges and seal will be similar to a liquid filled pressure balanced vessel. It is pressure tolerance of the components inside the vessel (i.e. electronic, electrical, others) that will decide the pressure limitation.

If favourable, the components of the subsea SSR can be segregated in an optimum way according to their tolerance to liquid, pressurised liquid and pressurised gas. The components can be arranged in vessels in the following way:

The most robust components can be installed in a vessel illed with pressurised liquid

Liquid tolerant components that have low tolerance to pressure can be installed in another low pressure liquid filled vessel

Components that do not tolerate liquid but tolerate high pressure gas can be installed in a high pressure vessel

Components that only tolerate low pressure gas an be installed in a vessel with low pressure gas.

Suitable cooling has to be applied for the different vessels.

Components in the various vessels will be connected as needed by wires that go through penetrators in the vessel walls. Subsea mateable connectors can also be arranged between the vessels to make them separately installable and retrievable.

It shall be mentioned that the above described segregation to achieve an optimum arrangement of the components of a susbsea SSR in different vessels, taking into account the number of penetrators and connectors needed, also can be applied for subsea variable speed drives (VSD).

### Some Considerations

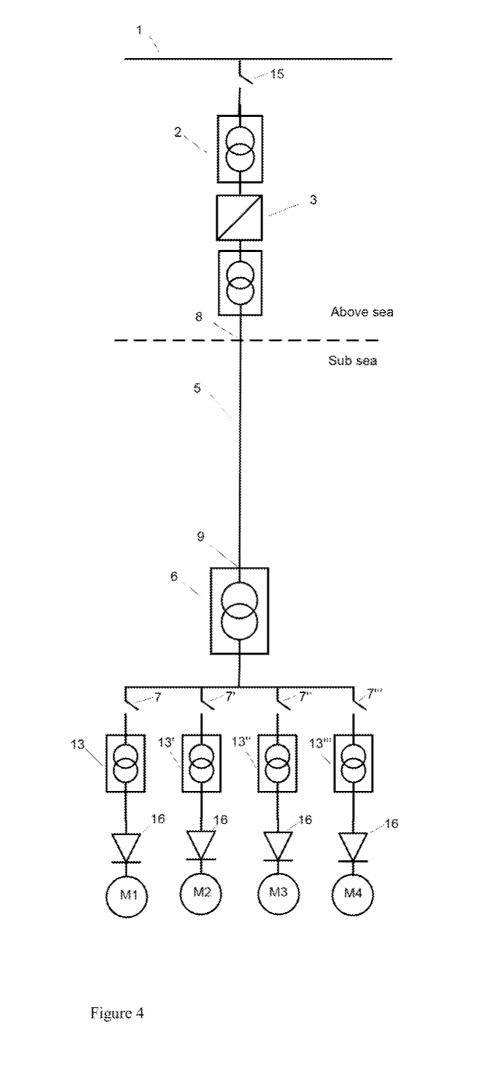

The speed of a DC motor is directly proportional to the supply voltage. The arrangement of subsea rectifiers connected to variable subsea transformers in FIG. 4 therefore allows individual speed control of the DC motors and individual start of motors.

The above mentioned devices and methods make it possible to manage the Ferranti effect and skin effect and thereby considerably extend the distance for stable subsea high-voltage power transmission.

Hence maximum practical step-out distance can be very much increased . . . .

If the SACS has oil lubricated bearings, there is no need for any control system of the unit, and possible instrumentation can be limited to monitoring, e.g. vibrations and temperature, if found beneficial.

Speed of compressors can typically range from e.g. 4000 to 14000 rpm and of pumps from e.g. 2000 to 5000 rpm.

In Table 2 is explained the meaning of the items in the figures.

TABLE 2
Figure labels.

| Item # | Explanation |
|---|---|
| 1 | Electric power supply grid |
| 2, 2′, 2″, 2′″ | Step-down transformer |
| 3, 3′, 3″, 3′″ | VSD, Variable Speed Drive |
| 4, 4′, 4″ 4′″ | Step-up transformer |
| 5, 5′, 5″, 5′″ | Transmission cable |
| 6, 6′, 6″, 6′″ | Step-down transformer |
| 7, 7′, 7″, 7′″ | Circuit breaker |
| 8, 8′, 8″, 8′″ | Near end of transmission cable |
| 9, 9′, 9″, 9′″ | Far end of transmission cable |
| 13, 13′, 13″, 13′″ | Step-down transformer |
| 14, 14″, 14″, 14′″ | VSD |
| 15, 15″, 15″, 15′″ | Circuit breaker |
| 16, 16′, 16″, 16′″ | Rectifier |
| M | Motor of subsea motor-DC generator set, SDCS |
| G | DC generator of subsea motor-DC generator set, SDCS |
| M1, M2, M3, M4 | DC motor for e.g. compressor |

### DETAILED DESCRIPTION

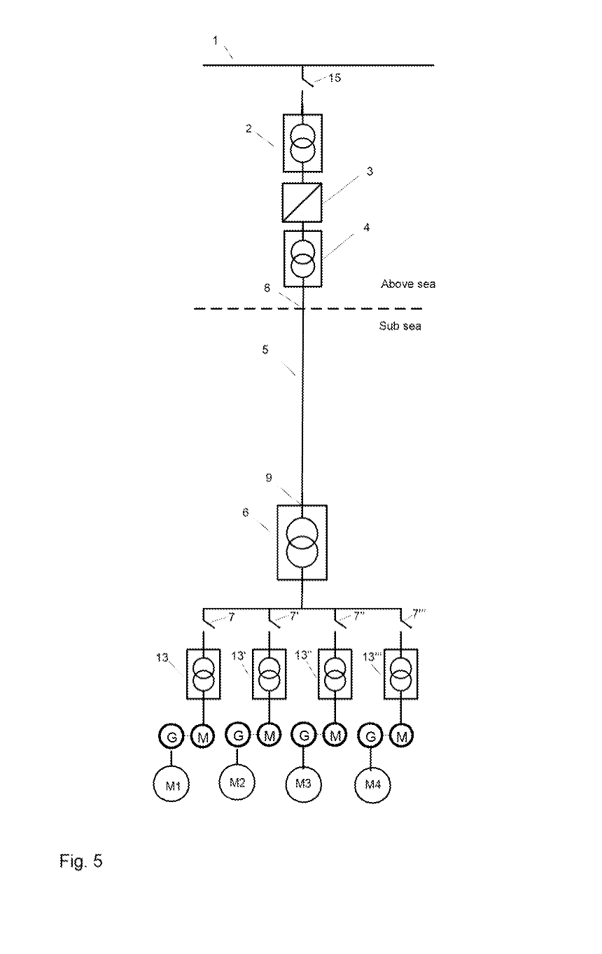

Reference is made to FIG. 4, illustrating a specific embodiment of the SSR type of the present invention, Node 1 is connected to a source for electric power; the source is a local power grid or, for instance, a local power generation system, A VSD 3 is connection to power source. A VSD input transformer 2 is often connected in between in order to adjust the supply voltage, e.g. 13.8 kV for a platform to the rated VSD voltage, e.g. 6 kV. The transformer can be an integrated part of the VSD as offered by some suppliers. Normally a step up transformer 4 is needed to connect the VSD 3 to the high-voltage transmission line 5 that in the example of a subsea application consists of a cable. A typical voltage applied to the cable could for instance be about 120 kV. The cable is laid into the sea in order to extend from the near end 8 to the subsea far end 9; the cable has any operative length where the Ferranti effect starts being observed until where it strongly dominates to the load current. This can be translated to length in the order 20 km, to 100 km and probably beyond, dictated by the location and properties of the subsea loads. At the far end 9 of the cable, a subsea transformer 6 is arranged, stepping down the voltage to for example 20 kV suitable for the circuit breakers 7, 7′, 7″, 7′″, followed by transformer 13, 13′, 13″, 13′ stepping down to for example 6 kV suitable for SSR (FIG. 4) or SDCS (FIG. 5). Four subsea motors are illustrated, which for instance could be two compressor motors M1, M2 and two, pump motors M3, M4.

The step down transformers 13, 13′, 13″, 13″′ are in principle optional because the step-down transformer 6 (ref. FIGS. 4 and 5) can directly step-down the voltage suitable for SSR, or SDCS. Inclusion of 13, 13′, 13″, and 13′″ is a question of optimisation of the far end power distribution system.

It shall be emphasised that the key components of the power transmission systems of FIG. 4′ are the power source 1, the transformer 2, the transformers 13, 13′, 13″, 13″, the transmission cable 5 and the SSR 16, 16′, 16″, 16′″ or the SDCS in FIG. 5. The other components are included according to need from case to case.

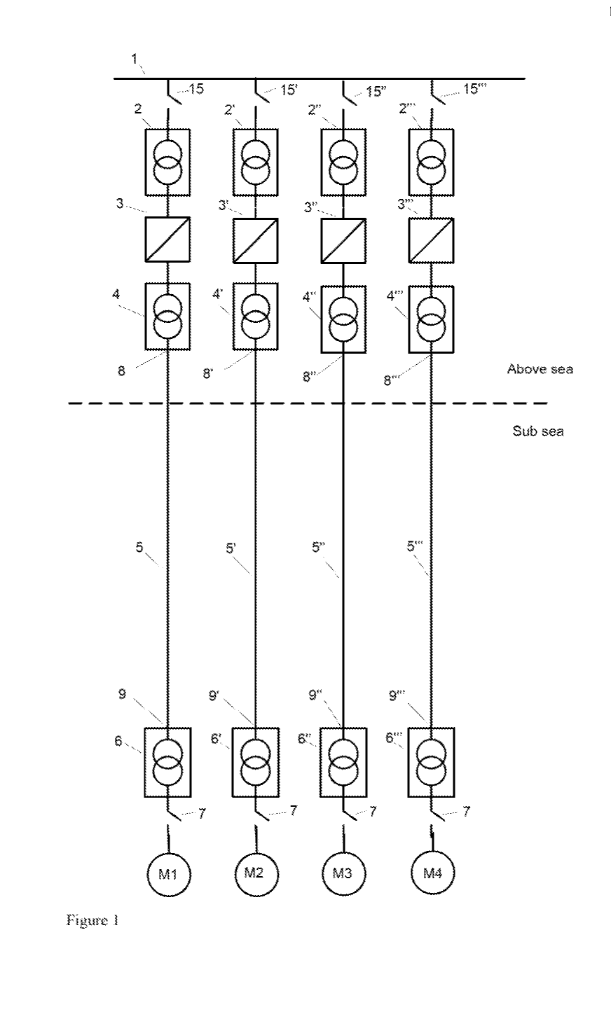

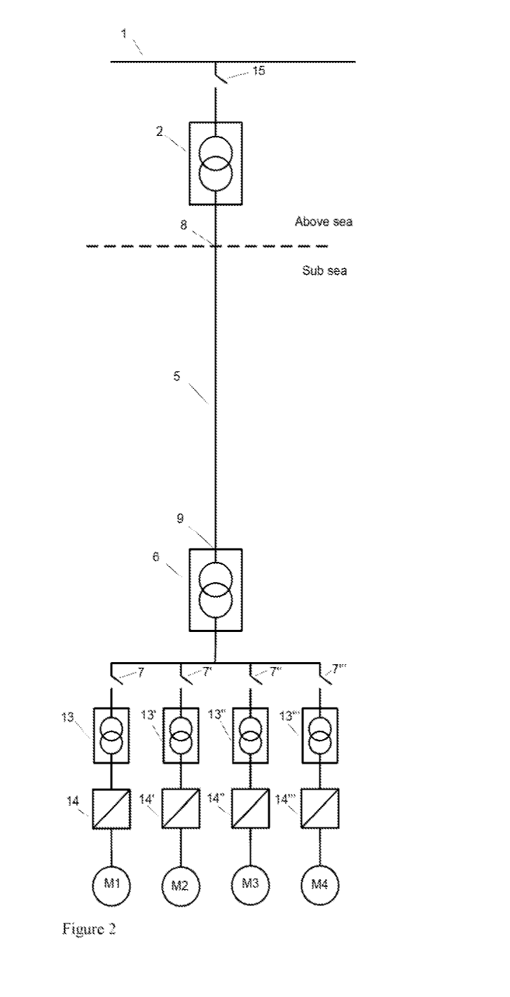

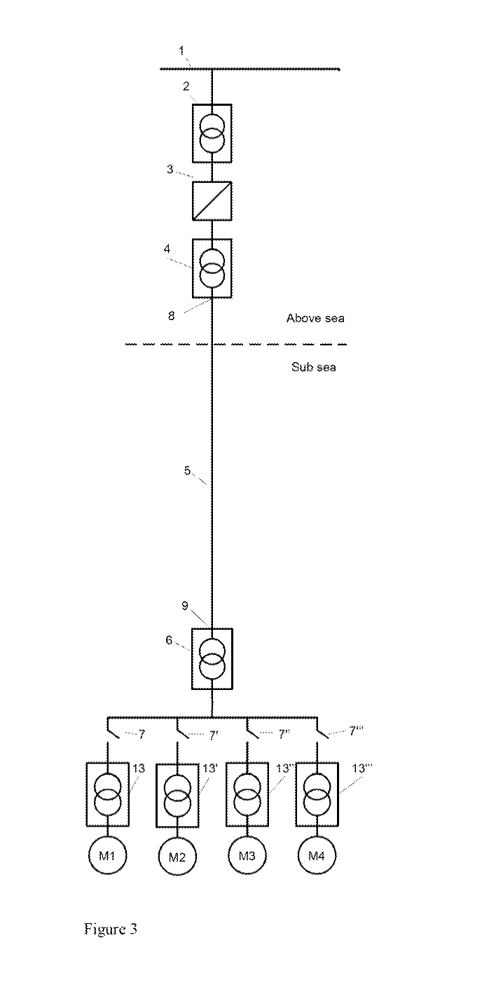

Cost of long subsea cables and subsea VSDs is high, and subsea VSDs ire FIG. 2 have a negative impact on system reliability as well as being expensive. One common transmission cable compared to the solution in FIG. 1 represents a considerable saving in investment.

It shall be mentioned that even though one common transmission cable is beneficial of cost reasons, there is technically no problem to have one transmission cable for each SDP. This may be the optimum solution for medium step out lengths, say 35 to 75 km, i.e. up to distances where the cable cost does not become prohibitive.

### Condensed Description of the Invention

It is problematic or even not possible to transmit high voltage high power electricity at high frequency, say more than 100 Hz, over long subsea step-up distances, say more than 40 km, to supply motors operation at high speed for subsea pumps and compressors. This is due to the Ferranti effect that can crate over voltage and instability in the transmission system as well as the skin effect that creates high ohmic resistance and consequently high voltage and power losses.

Subsea variable speed drives to which the transmission frequency can be low, e.g. 50 Hz, presents a solution to this. They are however big and equipped with a large amount of sensitive, fragile electric and electronic components and control system, which additionally to making them expensive also are assumed to have a high failure rate.

The invention offers a solution to this by having a VSD or other control element only at surface, electric power is transmitted at the grid frequency, e.g. 50 or 60 Hz, or lower if required due to the Ferranti effect and losses.

The Invention with Subsea AC/DC Rectification (SSR) or Subsea Motor-DC Generator Set (SDCS) to Run DC Motors

The invention makes it possible to have surface located frequency control or no frequency control for speed control of subsea motors at long step-out distances, by rectifying transmitted AC to DC or producing DC by a motor-DC generator set at a subsea location near the motors. Near means in this context near enough to keep acceptable the ohmic resistance drop and thereby power loss between the rectifier and the motors. Reference is given to FIG. 4 that illustrates a transmission system from a surface located VSD to a subsea rectifier that supplies DC to subsea motors and also to FIG. 5 with SDCS.

In the following will be more described use of the static type with solid state diodes. This description is also valid for any other type of rectifier.

The rotating speed of the motors will be by the established way for DC motors, i.e. control of shunt, series or compound motors.

The speed of a DC motor is directly proportional to the supply voltage. Therefore a suitable way of adjusting the speed is to have a transformer with adjustable output voltage upstream the SSR and thereby the motor voltage and speed, e.g. by tap changing. Most obviously this could be the subsea transformer 13, 13′, 13″, 13′″ directly upstream the rectifier 16 in FIG. 4, but it could also be transformer 6 or the surface located transformer 4 or a combination of these.

In the case of SDCS, the output voltage of the DC generator can be adjusted by a voltage regulator for the generator and thereby adjust the speed of the connected motor, e.g. a compressor motor.

Alternatively one common SDCP can be used for several motors. Individual speed control can in such cases be done by shunt, series or compound arrangement.

1. A device for operative connection between a subsea step out cable far end and subsea loads such as pumps, compressors and control systems, wherein the device is a subsea DC provider (SDCP), the device comprising:
a SDCP unit for altering alternating current power received from the step out cable to direct current power for delivery to said loads;
a gas and/or liquid filled vessel into which said unit is arranged;
wherein the device is a SDCP for subsea location at a far end of a subsea step out cable connected to at least one AC power source at the step out cable near end, and the step out length is long enough to cause stability problems at frequency and power levels feasible for subsea pump and compressor motors; and
where the device via the step out cable receives input electrical power at a low enough frequency to have stable transmission and the device, operatively connected to the subsea motors, delivers a DC output electrical amperage and voltage feasible for operation of connected pump and compressor motors.

2. The device according to claim 1, comprising at least one of a motor-DC generator set (SDCS) and a static rectifier (SSR).

3. The device according to claim 1, comprising a pressure compensator and at least one penetrator for electric connection of said unit to outside the pressure vessel.

4. The device according to claim 1, wherein the device is installed in a pressure vessel or housing that is filled with gas.

5. The device according to claim 1, wherein a VSD (Variable Speed Drive) is connected at the step out cable near end to adjust the low frequency transmission frequency.

6. The device according to claim 1, wherein the transmission frequency from the power source at the near end is fixed.

7. The device according to claim 1, wherein there is one SDCP per motor.

8. The device according to claim 1, wherein several motors are connected to one subsea SDCP.

9. The device according to claim 1, wherein the subsea rectifier is of the static type (SSR)

10. The device according to claim 1, wherein the subsea rectifier is of the static type (SSR) with solid state diodes.

11. A system for subsea pressure boosting of hydrocarbon fluid or other fluid, the system comprising:
a subsea step out cable, connected to a an electric AC power source at a near end, the length of the subsea step out cable is too long for stable operation at frequency and power level feasible for subsea pumps or compressors;
subsea pumps or compressors operatively connected to a far end of the subsea step out cable; and
a subsea DC provider arranged between the subsea step out cable and DC motors of subsea pumps or compressors.

12. The system according to claim 11, wherein the subsea DC provider comprises at least one of a motor-DC generator set (SDCS) and a static rectifier (SSR), arranged in a vessel filled with liquid or gas.

13. The system according to claim 11, wherein the subsea DC provider has no means for active control or adjustment on site subsea, the subsea DC provider is arranged in a liquid filled vessel, with a pressure compensator and at least one electric penetrator.
